(19) United States
(12) Patent Application Publication
(10) Pub. No.: US 2010/0176359 A1
(43) Pub. Date: Jul. 15, 2010

(54) Vehicle Jack With Extension Feedback

(76) Inventor: Craig Wisner, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 12/686,807

(22) Filed: Jan. 13, 2010

Related U.S. Application Data
(60) Provisional application No. 61/144,624, filed on Jan. 14, 2009.

(51) Int. Cl. B60S 9/08

(52) U.S. Cl. 254/425

(57) ABSTRACT

A screw jack for lifting a vehicle that includes an outer sleeve section and a threaded section that rotates relative to the outer sleeve section. The screw jack also includes a drive assembly with a rotary position sensor. The drive assembly is in driving engagement with the threaded section. The screw jack also includes an extending section that translates relative to the outer sleeve section and the threaded section and is driven by the threaded section. Extension of the extending section is continuously monitored using the signal from the rotary position transducer when the jack is in operation.

### CROSS-REFERENCE TO RELATED APPLICATION

This claims the benefit of U.S. Provisional Patent Application No. 61/144,624 filed Jan. 14, 2009, the disclosure of which is hereby incorporated by reference for all purposes.

### STATEMENT REGARDING FEDERALLY SPONSORED RESEARCH OR DEVELOPMENT

Not applicable.

### FIELD OF THE INVENTION

The invention relates to a device for leveling a vehicle on extendable lift mechanisms.

### BACKGROUND OF THE INVENTION

In the area of recreational vehicles such as travel trailers and motor homes, and other general transportable vehicles, there is a need for leveling when these vehicles are parked for use. Recreational vehicles and campers are usually parked in campsites where the parking area is not always level. Various systems are found in the prior art relating to leveling such vehicles. These systems comprise at least a lift mechanism and a level sensing device. Generally, the designs use mechanical, electromechanical, or hydraulic jacks and level sensors for leveling the vehicles. The devices are strategically mounted to the underbody or chassis of the vehicle to achieve leveling quickly and efficiently. The numbers of jacks and level sensors used in each application are dependent on the size of the vehicle and the weight of the vehicle being supported, among other things. In one example, a recreational vehicle is equipped with four jacks in the form of hydraulic cylinders mounted to the vehicle frame. Two jacks are located adjacent to the rear of the vehicle and two jacks are located adjacent to the front of the vehicle.

The lift mechanisms used with prior art designs typically include sensors that indicate if the lift mechanism has reached the end of its stroke in either the extending or retracting direction. For example, some designs include two magnets fixed to the extending section of each lift mechanism. One of the magnets is positioned such that it is adjacent to a sensor when the extending section has reached the end of its stroke in the extending direction. The sensor sends a signal to a controller that prevents the lift mechanism from extending further. The other magnet is positioned such that it performs a similar function when the extending section has reached the retracted position.

These prior art lift mechanisms are limited because the controller can only determine if the extending section of each jack is in two positions: the extended position and the retracted position. Problems may arise when attempting to level a vehicle with these prior art lift mechanisms because the controller cannot determine the exact intermediate position of the extending section of each jack. For example, it may be important to determine how far each extending section has moved since contact with the ground has been established. However, prior art designs cannot make such a determination with the sensors discussed above. To ensure the extending sections remain in contact with the ground, prior art lift mechanisms only attempt to level the vehicle by further extending the extending sections. If the jack to be extended further reaches the end of its stroke and the vehicle is not level, the controller cannot level the vehicle without intervention by a human operator. Therefore, an improved lift mechanism for leveling a vehicle is needed.

### SUMMARY OF THE INVENTION

The present invention provides a screw jack for lifting a vehicle that includes an outer sleeve section and a threaded section that rotates relative to the outer sleeve section. The screw jack also includes a drive assembly with a rotary position sensor. The rotary position transducer may be a Hall effect sensor. The drive assembly is in driving engagement with the threaded section. The screw jack also includes an extending section that translates relative to the outer sleeve section and the threaded section and is driven by the threaded section. Extension of the extending section may be monitored using the signal from the rotary position transducer.

In another aspect of the invention, the vehicle may include a plurality of screw jacks in addition to at least one level sensor capable of sending a signal based on the orientation of the vehicle. The vehicle may also include a controller operably connected to the drive assembly and capable of receiving signals from the rotary position transducers of the jacks and the at least one level sensor. The controller may be capable of determining if the vehicle can be leveled by extending the extending section of at least one of the screw jacks. Similarly, the controller may be capable of determining if the vehicle can be leveled by retracting the extending section of at least one of the screw jacks.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

FIG. 1 is a perspective view of a vehicle incorporating the present invention;

FIG. 2 is a schematic top view of the chassis of the vehicle of FIG. 1;

FIG. 3 is a side view of a screw jack according to the present invention;

FIG. 4 is a partial section view of the screw jack of FIG. 3;

FIG. 5 is a plan view of a control pad for the vehicle; and

FIG. 5A is a detail view of a keypad of the control pad of FIG. 5.

### DETAILED DESCRIPTION OF THE PREFERRED EMBODIMENT

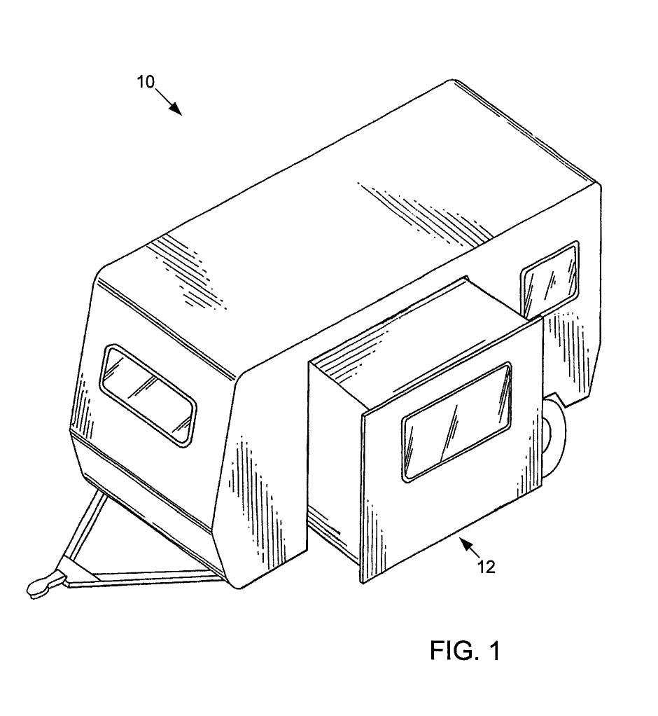

Referring to FIG. 1, a vehicle 10 incorporating the present invention may be a travel trailer with a slide-out room 12. Such vehicles and rooms are well known in the art. The present invention may also be used with other types of recreational vehicles, such as motor homes, or other types of vehicles and trailers that require leveling when parked.

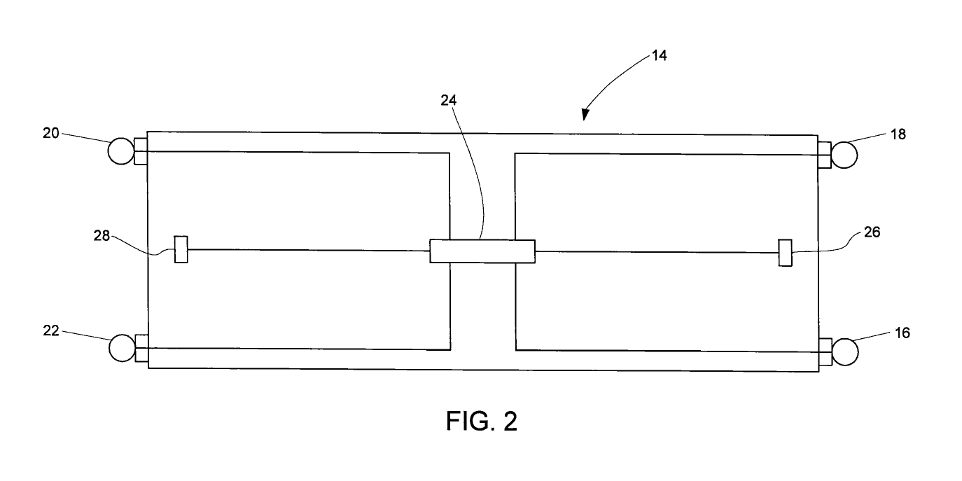

Referring to FIG. 2, the chassis 14 of the vehicle preferably connects to four lift mechanisms. The lift mechanisms are preferably screw jacks 16, 18, 20, and 22. Screw jack 16 is located at the front right corner of the chassis 14, screw jack 18 is located at the front left corner, screw jack 20 is located at the rear left corner, and screw jack 22 is located at the rear right corner. Operation of the screw jacks 16, 18, 20, and 22 is controlled by a controller 24. The controller 24 also receives signals from two level sensors 26 and 28. Operation of the screw jacks 16, 18, 20, and 22 by the controller 24 in conjunction with the level sensors 26 and 28 will be discussed in further detail below.

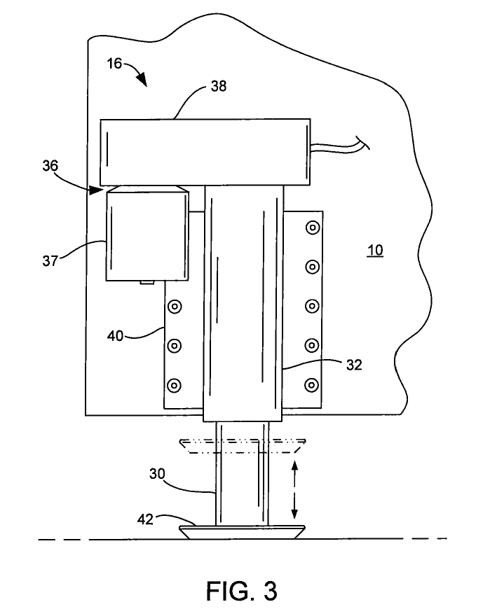

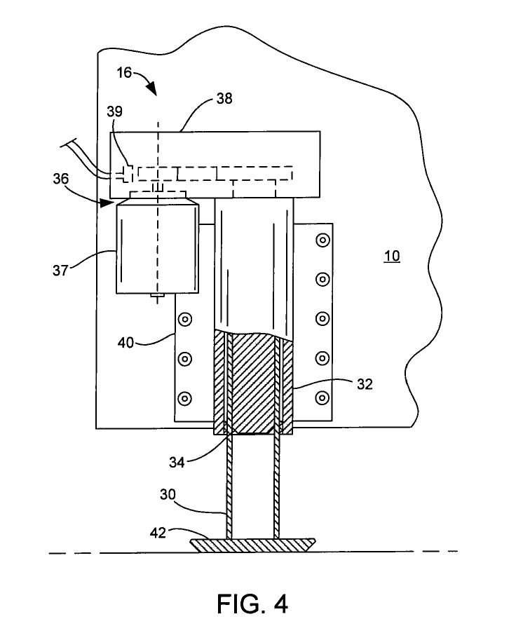

Referring to FIGS. 3 and 4, a screw jack 16 used with the present invention includes an extending section 30, an outer sleeve section 32, a threaded section 34, and a drive assembly 36. The screw jack 18 is connected to the vehicle 10 by bracket 40 that is fixedly connected to the outer sleeve section 32. The bracket 40 may be connected to the vehicle 10 and the outer sleeve section 32 by any appropriate means, such as welding or using fasteners. The extending section 30 translates relative to the other components of the screw jack 16 and connects to a support base or foot 42 that contacts the ground. The extending section 30 extends and retracts inside the outer sleeve section 32. The extending section 30 also threadably engages and is driven by the threaded section 34. The threaded section 34 rotates relative to the extending section 30 and the outer sleeve section 32 and is driven by the drive assembly 36. The drive assembly 36 preferably includes a drive motor 37 and a speed reducer 38. The speed reducer 38 preferably provides a speed reduction of 117:1. It should be understood that the screw jacks 18, 20, and 22 include the same components as the screw jack 16.

Referring to FIG. 4, the drive assembly 36 includes a rotary position transducer 39, for example, a Hall effect sensor, that sends a signal to the controller 24. Hall effect sensors are well known in the art and are capable of sensing changes in magnetic fields. Accordingly, a Hall effect sensor may be included in the drive assembly 36 to monitor the angular position of a component of the drive assembly 36, such as a disc with a plurality of magnetic strips or a gear. The location of the rotary position transducer 39 may be modified based on the type of component the transducer monitors. For either alternative, the extension distance of the extending section 30 can be determined by the controller 24 based on the angular position of the disc or gear and the pitch of the threaded section 34. In addition, the reduction ratio of the speed reducer 38 may also be used to determine extension distance depending on the location of the transducer 39. Each of the screw jacks 16, 18, 20, and 22 preferably includes a Hall effect sensor and the controller 24 preferably continuously monitors the extension distance of the extending section 30 of each of the screw jacks during a leveling operation. The controller 24 is also preferably capable of determining how far the extending section 30 of each of the screw jacks may physically move in extension and retraction during a leveling operation. In addition, the controller 24 is also preferably capable of informing a user of the extension distance of each of the screw jacks. This may be done by including a display screen that is operably connected to the controller 24.

Alternatively, the drive assembly 36 may include other types of rotary position transducers instead of a Hall effect sensor. For example, optical encoders and potentiometers may also be used. These sensors are well known in the art, and other types of well known rotary position transducers may be used provided that the controller 24 can use the signal from the transducer to determine the extension distance of the extending section 30 of each of the screw jacks 16, 18, 20, and 22.

The controller 24 needs to establish a reference point for moving the extending section 30 of each of the screw jacks 16, 18, 20, and 22 when the vehicle is first used. This is achieved by using a current sensor (not shown) that is capable of monitoring the current in each screw jack separately. Low power is applied to the screw jacks so that the extending sections 30 extend slowly. The current sensor will measure a sudden current increase when the extending section 30 of a single screw jack cannot extend further, or has reached a hard stop. The controller 24 uses this angular position of the disc or gear as the reference point of the single screw jack. In addition, the controller 24 may use a similar method to determine the retracted position of the extending section 30 for each of the screw jacks, or the distance the extending section 30 may move from the extended position may be preprogrammed in the controller 24.

The extending sections 30 move quickly after the extended and retracted positions of the extending section 30 of each of the screw jacks 16, 18, 20, and 22 are stored in the controller 24. However, the extending sections 30 preferably move slowly in two soft stop areas near the extended and retracted positions. This prevents the extending sections 30 from abruptly striking the hard stops in the extended and retracted positions. Abruptly striking the hard stops may damage components of the screw jacks due to the high torque output of the drive motor 37.

The controller 24 is preferably capable of storing the position at which the foot 42 of each of the screw jacks 16, 18, 20, and 22 contacts the ground. This is possible using the level sensors 26 and 28 and the rotary position transducers described above. Specifically, the foot 42 of each of the screw jacks causes the orientation of the chassis 14 to change abruptly when the foot 42 contacts the ground. The change in orientation of the chassis 14 is unique for each of the feet 42 of the screw jacks. The level sensors 26 and 28 are capable of sending a signal to the controller 24 in response to each orientation change of the chassis 14, and the controller 24 can correlate each orientation change to the position of the screw jack when contact occurred. Alternatively, the current sensor, if it is included, may be used to determine the ground contact point of each of the screw jacks. This is possible since the current in each screw jack suddenly increases when the foot 42 of the screw jack contacts the ground. The controller 24 can correlate each current increase to the position of the screw jack when contact occurred. For either alternative, the ground contact point for each of the screw jacks can be stored by the controller 24 to subsequently monitor how far each of the screw jacks has moved since contacting the ground.

In addition, the controller 24 can determine the slope of the ground based on signals from the level sensors 26 and 28 and the rotary position transducers described above. This is determined by comparing the extension distance of the extending sections 30 of the screw jacks 16, 18, 20, and 22 provided that the chassis 14 is level. This capability allows the controller 24 to determine if a single side of the chassis 14 is located above a low spot, such as a ditch, or to determine if a single corner of the chassis 14 is located above a low spot, such as a hole. Accordingly, this allows the controller 24 to determine if a single corner or an single side of the chassis 14 should be raised to level the chassis 14.

Further still, this system may level the chassis 14 of the vehicle 10 by extending screw jacks or retracting screw jacks. The controller 24 first determines if the chassis 14 can be leveled by further extending any of the screw jacks. As discussed above, the present position, the extended and retracted positions, and the ground contact point of each of the screw jacks is stored by the controller 24. This allows the controller 24 to determine if the chassis 14 can be leveled before the screw jack to be extended reaches its extended position. If this is not possible, the controller 24 next determines if the chassis 14 can be leveled by retracting any of the screw jacks. This is possible because the controller 24 can determine how far each screw jack can be retracted before losing contact with the ground. The controller preferably checks the level sensors after any of the screw jacks are extended or retracted in case the jacks moved past a position that would level the chassis 14. This can be corrected by subsequently extending or retracting some of the screw jacks.

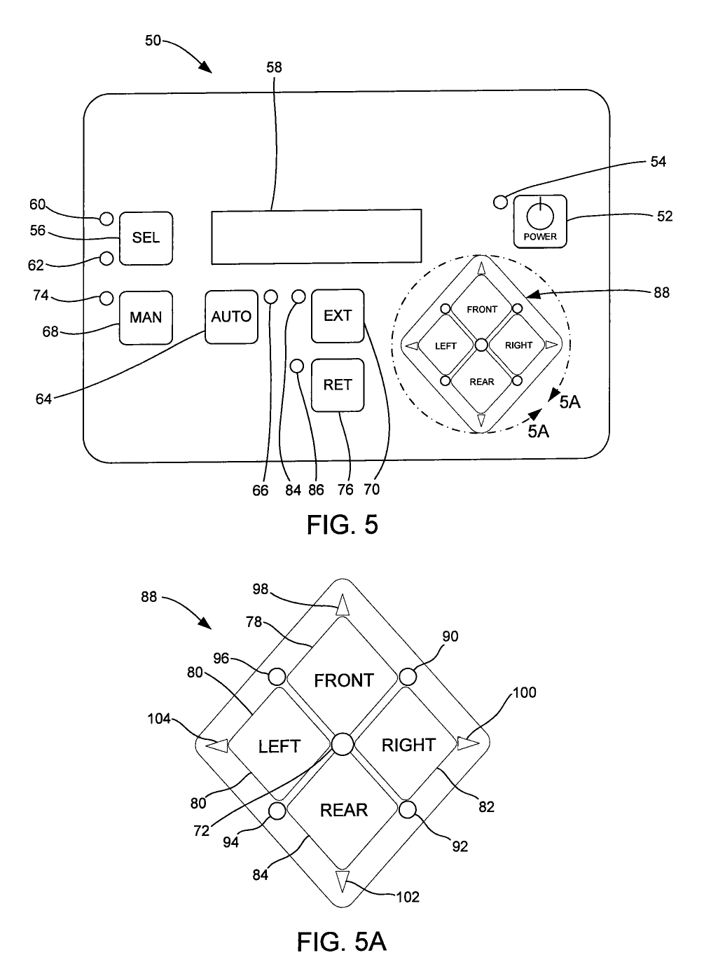

Referring to FIGS. 5 and 5A, the present invention may include a control pad 50 to permit a user to control operation of the system. It should be understood that the control pad 50 is intended to be an example of a device used to control the system. It is possible to use other types of control pads and their associated operations. The control pad 50 may be enclosed in an accessory panel (not shown) that is mounted on the side of the vehicle 10. The accessory panel, if included, is accessible from outside of the vehicle 10. The control pad 50 is activated by pressing power button 52. LED 54, when illuminated, indicates that power is on and control pad 50 is ready for operation. Select button 56 is used for scrolling through the displayed information on touchpad screen 58. LED 60, when illuminated, indicates that the vehicle 10 is level. LED 62, when illuminated, indicates that the vehicle 10 is not level. If LED 62 is illuminated, error messages will be shown on the screen 58, including, low voltage, end of stroke, etc. Select button 56 may be additionally used to cycle through three predefined leveling operations. The three leveling operations are side to side front, side to side rear, and front to rear. The screen 58 may display the leveling operations of the vehicle 10.

Still referring to FIGS. 5 and 5A, auto button 64 is used to initiate the automatic leveling cycle discussed above. LED 66, when illuminated, indicates that the auto button 64 is activated. In certain situations, however, it may be necessary to first extend some of the screw jacks while others remain stationary. This may enable some of the screw jacks to serve as landing gear. This may be achieved by pressing manual button 68 in conjunction with extend button 70. The automatic leveling cycle can then be initiated by pressing auto button 64. LED 72 illuminates and the screen 58 displays the message “Platform Level” when the vehicle 10 is level. LED 72 remains illuminated as long as the vehicle 10 is level.

Manual button 68 is used to initiate the manual leveling of the vehicle 10. Manual leveling may be required if automatic leveling cannot level the vehicle 10. Activation of manual button 68 is indicated by the illumination of LED 74. In manual mode, extend button 70 and retract button 76 can be pressed to extend or retract, respectively, individual pairs of screw jacks. For example, front button 78 extends screw jacks 16 and 18, left button 80 extends screw jacks 18 and 20, right button 82 extends screw jacks 16 and 22 and rear button 84 extends screw jacks 20 and 22. The screw jacks may also be extended individually. For example, the front button 78 and the right button 82 pressed simultaneously and held down result in only screw jack 16 extending. Activation of extend button 70 is indicated by the illumination of LED 84. Retract button 76 is used to retract the screw jacks in manual mode, indicated by LED 74 and LED 86. When manual button 68 and retract button 76 are pressed as indicated by the two LEDs 74 and 86, the directional keypad 88 works similarly to the way it works in manual extension mode, described above, to retract the jacks in pairs or individually.

Referring to FIG. 5A, keypad 88 contains directional buttons front 78, right 82, rear 84, and left 80, which are momentary contact switches. Keypad 88 also shows status LEDs 90, 92, 94, and 96 used in conjunction with the directional buttons in both automatic and manual leveling of the vehicle 10.

LEDs 90, 92, 94 and 96 light up when the screw jack they correspond to is being actuated. Their position on the keypad also indicates the corner of the vehicle at which they are positioned. Thus, LED 90 is between the front 78 and right 82 buttons and actuates the screw jack 16 that is at the front right corner of the vehicle 10. Pressing buttons 78 and 82 lights up only LED 90 and actuates only screw jack 16. This is the same for the other screw jacks 18, 20, 22 and the corresponding LEDs 92, 94, and 96.

LEDs 98, 100, 102 and 104 light up in the shape of arrows to indicate to the user which button to press to level the trailer in manual mode. Thus, if the rear of the vehicle is lower than the front, LED 102 will light and the user should press rear button 84 until LED 102 goes out.

It is specifically intended that the present invention not be limited to the embodiments and illustrations contained herein, but include modified forms of those embodiments including portions of the embodiments and combinations of elements of different embodiments as come within the scope of the following claims.

I claim:

1. A system for leveling a vehicle, comprising:
a plurality of screw jacks each including:
an outer sleeve section fixed relative to the vehicle;
a threaded section that rotates relative to the outer sleeve section;
a drive assembly that is in driving engagement with the threaded section and includes a rotary position transducer capable of sending a signal based on an angular position of a component of the drive assembly;
an extending section that translates relative to the outer sleeve section and the threaded section and is driven by the threaded section;
at least one level sensor capable of sending a signal based on the orientation of the vehicle;
a controller operably-connected to the drive assembly and capable of receiving the signal from the rotary position transducer and the signal from the at least one level sensor to control the screw jacks in response to the signals.

2. The system of claim 1, wherein the controller is capable of determining extension of the extending section from the signal of the rotary position transducer.

3. The system of claim 2, wherein the system includes a display to show extending section extension information.

4. The system of claim 1, wherein the component of the drive assembly is a disc with a plurality of magnetic strips.

5. The system of claim 1, wherein the component of the drive assembly is a gear.

6. The system of claim 1, wherein the drive assembly includes a drive motor, and the rotary position transducer is located within the drive motor.

7. The system of claim 1, wherein the rotary position transducer is a Hall effect sensor.

8. The system of claim 1, wherein the system includes a current sensor operably-connected to the controller and capable of sending a signal such that the controller is capable of separately monitoring current in each of the screw jacks.

9. The system of claim 8, wherein the controller is capable of determining reference points for each of the screw jacks from a signal from the current sensor.

10. The system of claim 1, wherein the controller is capable of determining a ground contact point for the extending section of each screw jack from the signal from the at least one level sensor.

11. The system of claim 8, wherein the controller is capable of determining a ground contact point for the extending section of each screw jack from the signal from the current sensor.

12. The system of claim 1, wherein the controller is capable of determining if the vehicle can be leveled by extending the extending section of at least one of the screw jacks.

13. The system of claim 12, wherein the controller levels the vehicle by extending the extending section of at least one of the screw jacks.

14. The system of claim 1, wherein the controller is capable of determining if the vehicle can be leveled by retracting the extending section of at least one of the screw jacks.

15. The system of claim 14, wherein the controller levels the vehicle by retracting the extending section of at least one of the screw jacks.

16. The system of claim 1, wherein the system includes four screw jacks.

17. The system of claim 16, wherein the screw jacks are located near corners of a generally rectangular chassis of the vehicle.

18. The system of claim 1, wherein the controller slows the drive assembly as hard stops of the assembly are approached by the extending sections of the screw jacks.
